(19) United States
(12) Patent Application Publication
(10) Pub. No.: US 2020/0274480 A1
(43) Pub. Date: Aug. 27, 2020

(54) PORTABLE, SOLAR ENERGY SYSTEMS FORMED FROM PLURALITY OF SOLAR ENERGY COMPONENTS

(71) Applicant: Solarflexes LLC, Milford, CT (US)

(72) Inventor: David Michael Lutian, Milford, CT (US)

(21) Appl. No.: 16/800,016

(22) Filed: Feb. 25, 2020

Related U.S. Application Data
(60) Provisional application No. 62/809,924, filed on Feb. 25, 2019.

(51) Int. Cl. H02S 30/20; F16M 11/22; F16M 11/24; B62D 63/08; B60P 3/00; B65D 90/00

(52) U.S. Cl. CPC H02S 30/20; F16M 11/22; F16M 11/24; F16M 2200/08; B60P 3/00; B65D 90/006; F16M 2200/06; B62D 63/08

(57) ABSTRACT

A solar energy system includes a plurality of photovoltaic (PV) assemblies. Each of the plurality of PV assemblies includes a plurality of PV components; at least one coupling structure coupled to each of the plurality of PV components; and a support structure coupled to the at least one coupling structure. The support structure includes at least two cross members coupled to and extending substantially perpendicular to the at least one coupling structure. The solar energy system also includes at least four legs coupled to one of the at least two cross member; and at least two adjustable arms extending between and coupled to one of the at least two cross members and one of the at least four legs.

This application claims the benefit of Provisional Application 62/809,924 filed Feb. 25, 2019.

### BACKGROUND OF THE INVENTION

The disclosure relates generally to portable solar energy systems, and more particularly, to portable solar energy systems formed from a plurality of photovoltaic (PV) components.

Conventional solar energy systems or fields typically require extensive preparation and/or installation. Specifically, preparation of the land in which the solar energy field will be installed on is often extensive and expensive. For example, once the site for the solar energy system has been chosen, the land must often be cleared, leveled or graded, and built-up (e.g., access roads to the site) before actual solar energy components may even begin to be installed. This process can take upwards of 9 to 12 months and cost million of dollars.

Furthermore, and dependent on size of the solar energy field, the preparation and/or installation of the solar energy components utilized within the solar energy field can also be time consuming and expensive. For example, each solar energy component, whether it be a photovoltaic (PV) component or a heliostat component, must be installed individually on-site. As such, the installation of all the solar energy components can take between 12 and 24 months. Additionally, the installation of the solar energy components that make up a solar energy field can cost over ten million dollars ($10,000,000 USD). As a result, conventional solar fields may take between 18 to 36 months before becoming operational, and cost tens of millions of dollars to create a single solar energy field.

### BRIEF DESCRIPTION OF THE INVENTION

A first aspect of the disclosure provides a solar energy system including a plurality of photovoltaic (PV) assemblies, each of the plurality of PV assemblies capable of being put into electronic communication with one another. Each of the plurality of PV assemblies including a plurality of PV components; at least one coupling structure coupled to each of the plurality of PV components; and a support structure coupled to the at least one coupling structure. The support structure includes at least two cross members coupled to and extending substantially perpendicular to the at least one coupling structure. The solar energy system also includes at least four legs coupled to one of the at least two cross member; and at least two adjustable arms extending between and coupled to one of the at least two cross members and one of the at least four legs.

A further aspect of the disclosure sets forth a solar energy system including a plurality of photovoltaic (PV) assemblies, each of the plurality of PV assemblies capable of being put into electronic communication with one another. Each of the plurality of PV assemblies including a plurality of PV components; at least one coupling structure coupled to each of the plurality of PV components; and a support structure coupled to the at least one coupling structure. The support structure includes at least two cross members coupled to and extending substantially perpendicular to the at least one coupling structure. The solar energy system also includes at least four legs coupled to one of the at least two cross member; and at least two adjustable arms extending between and coupled to one of the at least two cross members and one of the at least four legs. Also, the solar energy system has at least one of the at least four legs being adjustable; and at least one of the at least four legs being hingedly coupled to the at least two cross members. The at least two adjustable arms adjust at least one of angle, position, and tilt of the plurality of PV components of the plurality of PV assemblies.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an isometric view of a portable photovoltaic (PV) assembly of a solar energy system in a first operational state;

FIG. 2 shows a side view of portable PV assembly in the first operational state;

FIG. 3 shows an isometric view of portable PV assembly in a second operational state;

FIG. 4 shows a side view of portable PV assembly in the second operational state;

FIG. 5 shows the portable PV assembly in another operational states;

FIG. 6 shows a side view of a portable photovoltaic (PV) assembly of a solar energy system in an operational state, according to additional embodiments of the disclosure.

FIGS. 7-14 show various views of the portable PV assembly of FIGS. 1-5 in a collapsed state, according to embodiments of the disclosure.

FIGS. 15-17 shows various view of a solar energy system including a plurality of portable PV assemblies positioned within a storage container, according to embodiments of the disclosure.

FIGS. 18-25 show various views of one of the plurality of portable PV assemblies of the solar energy system of FIGS. 15-17 being installed and put in an operational state using a trailer of the solar energy system, according to embodiments of the disclosure.

FIGS. 26 and 27 show various views of a bracket included in the storage container of FIGS. 15-17 for receiving and securing a plurality of portable PV assemblies therein, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within the portable, solar energy systems. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure relates generally to portable solar energy systems, and more particularly, to portable solar energy systems formed from a plurality of photovoltaic (PV) components.

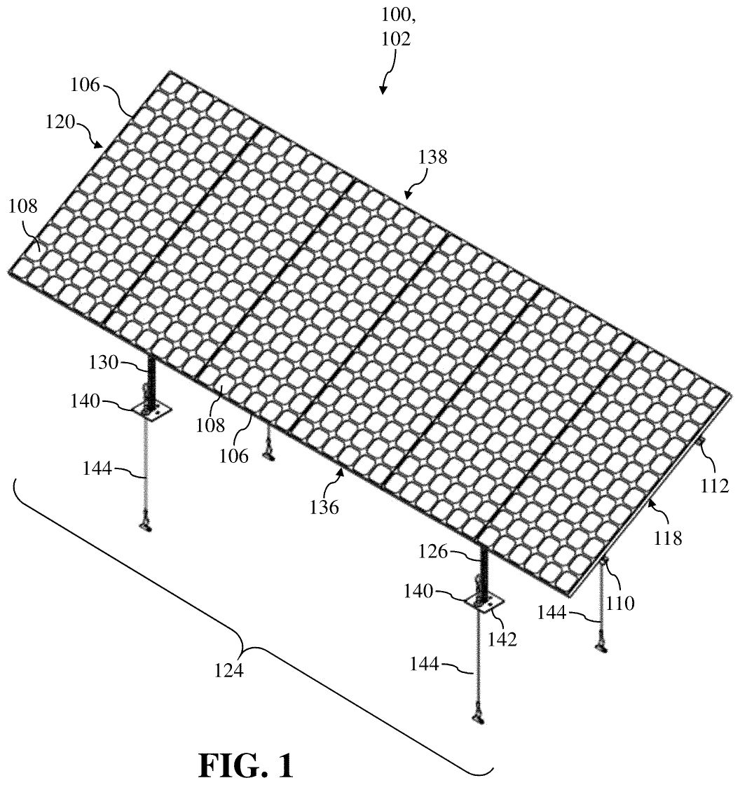

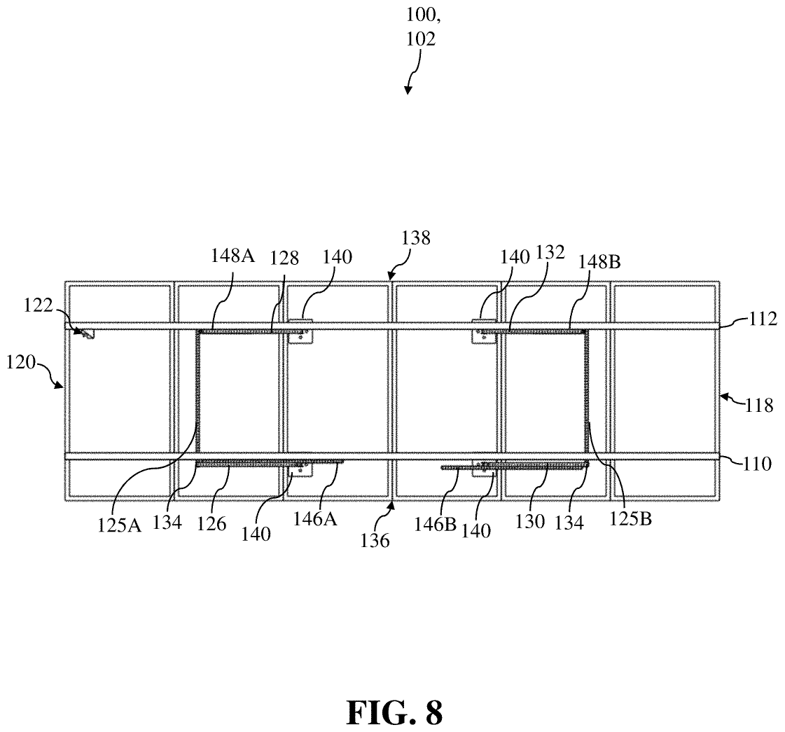

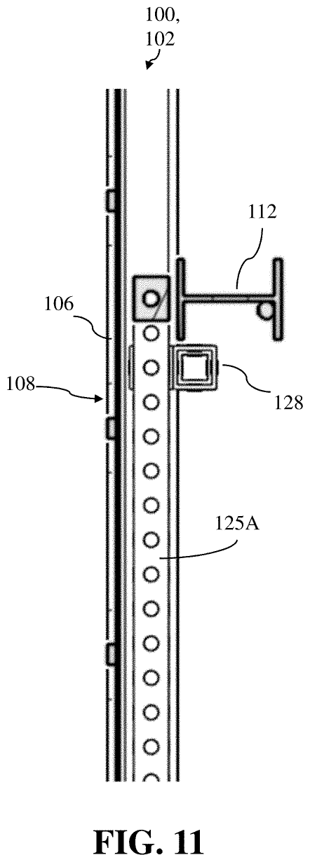

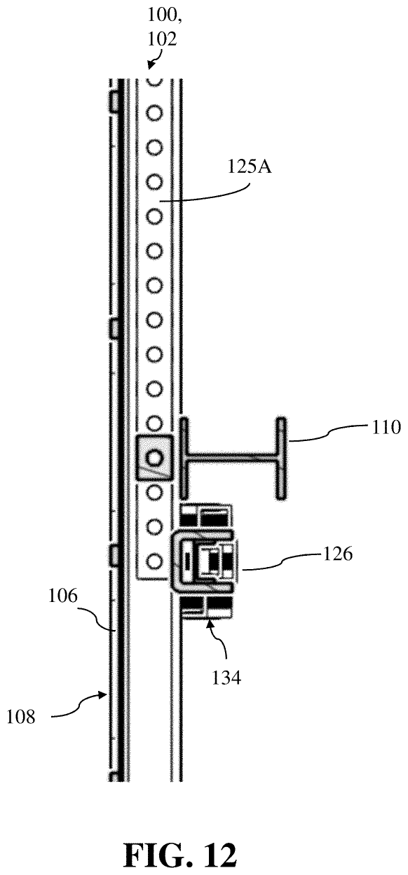

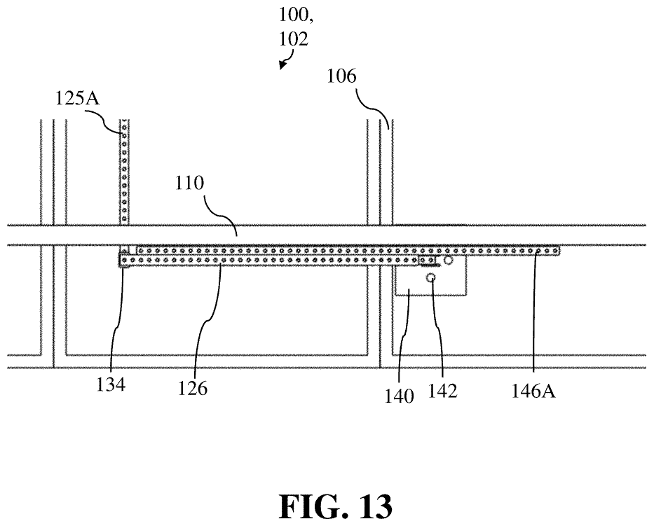

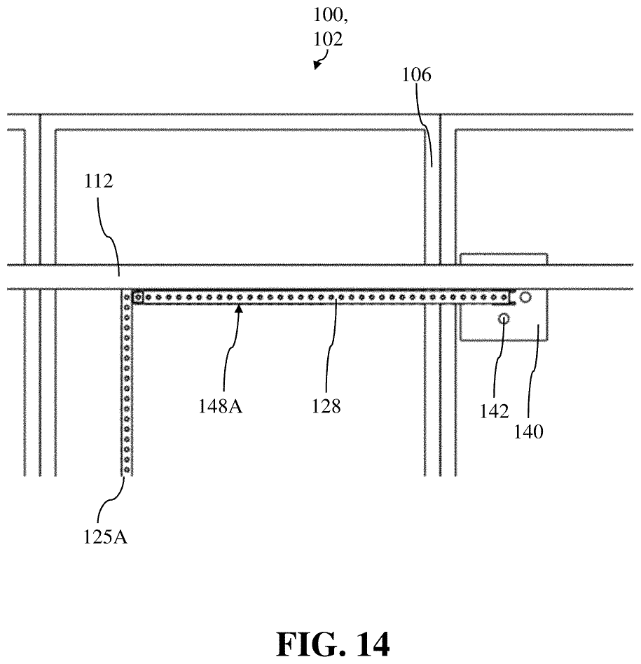

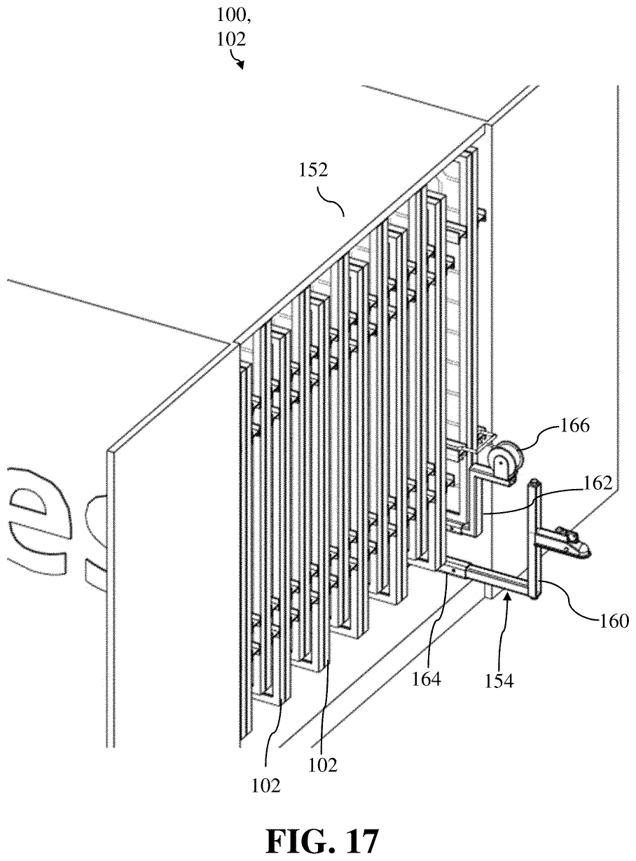

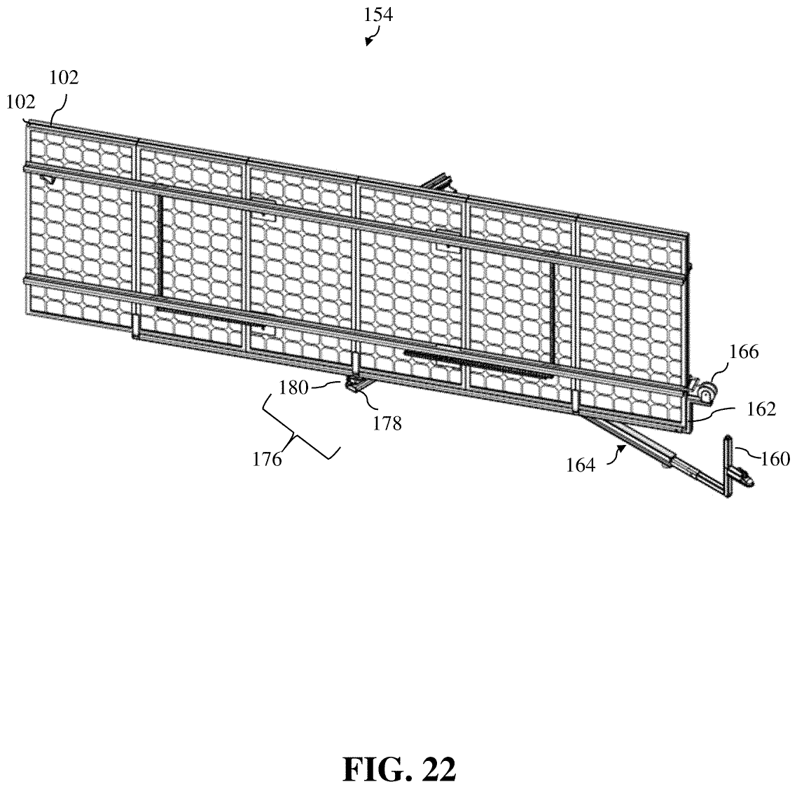

These and other embodiments are discussed below with reference to FIGS. 1-27. However, those skilled in the art will readily appreciate that the detailed description given herein with respect to these Figures is for explanatory purposes only and should not be construed as limiting.

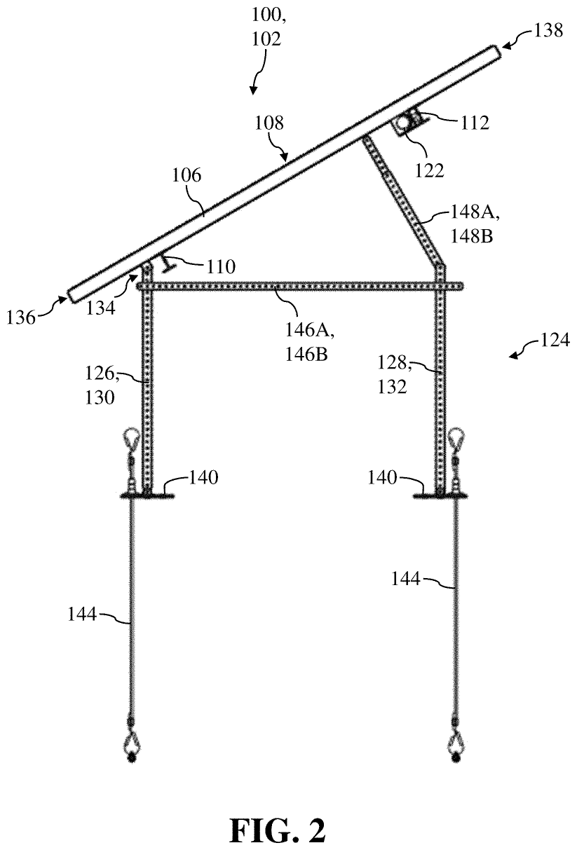

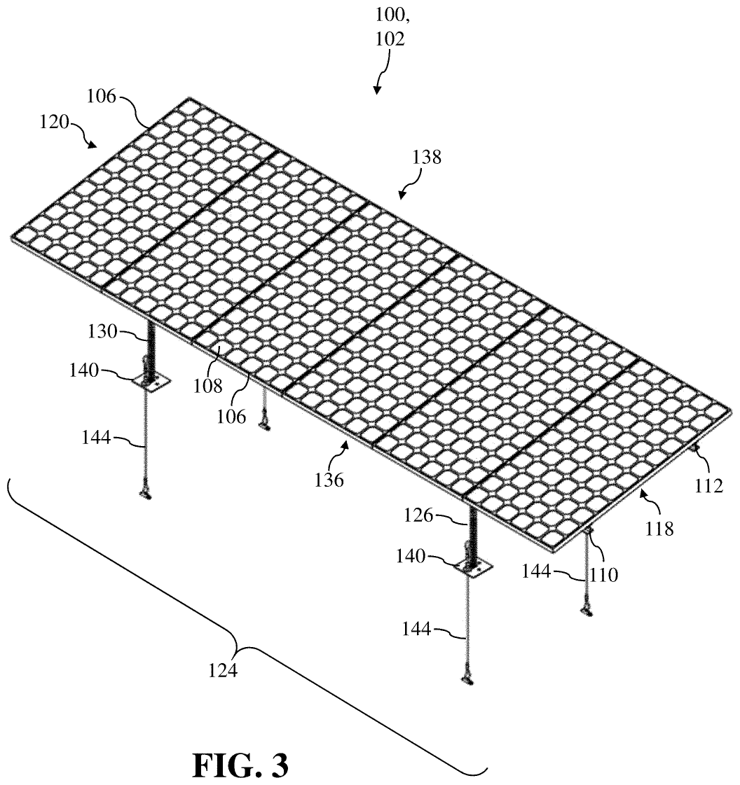

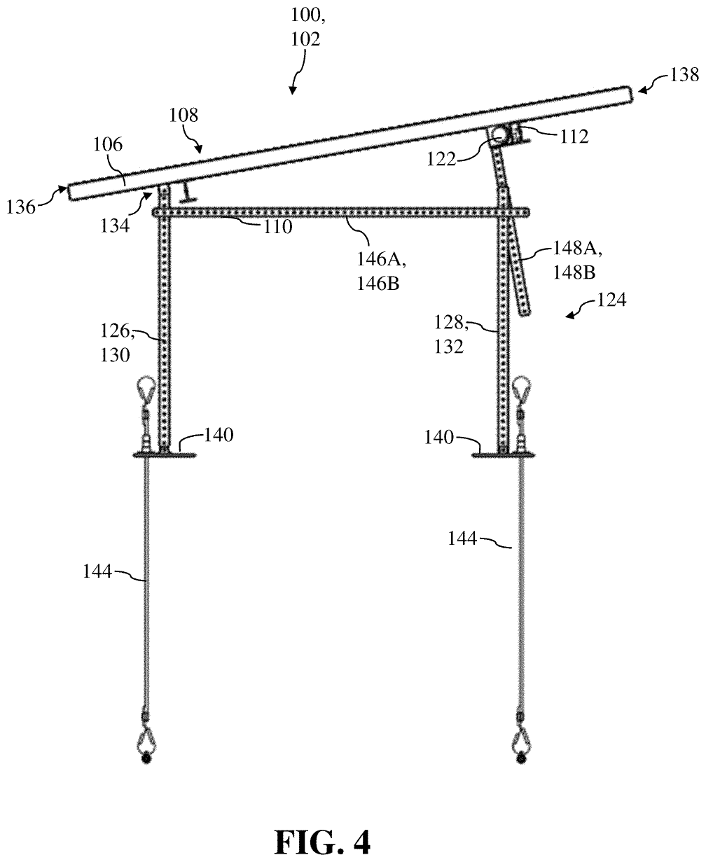

FIGS. 1-4 show various views of assemblies for forming a solar energy system 100 according to embodiments of the disclosure. More specifically, FIG. 1 shows an isometric view of a portable photovoltaic (PV) assembly 102 in a first operational state, FIG. 2 shows a side view of portable PV assembly 102 in the first operational state, FIG. 3 shows an isometric view of portable PV assembly 102 in a second operational state, and FIG. 4 shows a side view of portable PV assembly 102 in the second operational state. As discussed herein, one or more portable PV assemblies 102 may be in electronic communication with one another to form solar energy system 100. Additionally, and as discussed herein, a plurality of portable PV assemblies 102 may be shipped or transported together, and may be rapidly installed from a collapsed state using a trailer of solar energy system 100.

As shown in FIGS. 1-4, portable PV assembly 102 of solar energy system 100 may include a plurality of photovoltaic (PV) components 106. For example, portable PV assembly 102 may include six (6) distinct PV components 106, positioned adjacent one another and/or in series. In the non-limiting example, each of the plurality of PV components 106 may be formed as a solar panel including a collection of solar cells 108 configured to generate energy via solar power. The number of solar panels/PV components 106 of portable PV assembly 102 and/or the number of solar cells 108 included within each PV components 106 may be dependent, at least in part, on the size of PV assembly 102. That is, although portable PV assembly 102 is shown to include six distinct PV components 106, and/or each PV component 106 is shown to include seventy-two (72) solar cells 108, PV assembly 102 may include more or less PV components 106, and/or PV components 106 may include more or less solar cells 108.

The plurality of PV components 106 may be coupled and/or fixed together via two coupling structures 110, 112. More specifically, and as shown in FIGS. 1-4, portable PV assembly 102 may include two coupling structures 110, 112 that may be coupled to each of the plurality of PV components 106. Additionally, coupling structures 110, 112 may extend across substantially the entirety of PV components 106 of PV assembly 102. That is, coupling structures 110, 112 may extend substantially between opposing sides 118, 120 and/or over the entire width of the assembled, plurality of PV components 106 of PV assembly 102. In the non-limiting example, coupling structures 110, 112 may be formed as I-beams coupled to and extending over each of the plurality of PV components 106. As discussed herein, the angle or tilt of the plurality of PV components 106, coupled together via coupling structures 110, 112, may be adjusted or variable in the operational state for portable PV assembly 102.

In the non-limiting examples, each PV component 106 of portable PV assembly 102 may be in electrical communication and/or may be wired in parallel with one another. Additionally, each PV component 106 may include an electrical switch 122 (FIGS. 2 and 4) formed opposite solar cells 108 of each PV component 106. Electrical switch 122 (FIGS. 2 and 4) may allow for each PV component 106 to be operational and/or inoperable. That is, electrical switch 122 may control the operation of each PV component 106 individually. In a non-limiting example where one of the plurality of PV components 106 needs to be replaced and/or have maintenance performed thereon, electrical switch 122 of the identified PV component 106 may be switched to make the identified PV component 106 inoperable. However, while the identified PV component 106 is inoperable, the remainder of the plurality of PV components 106 forming PV assembly 102 may remain completely operational.

Portable PV assembly 102 may also include a support structure 124. Support structure 124 may support portable PV assembly 102 when installed and/or in the operational state. Support structure 124 may include cross members 125A, 125B extending between coupling structures 110, 112. More specifically, cross members 125A, 125B may extend between and may be positioned substantially perpendicular to coupling structures 110, 112 coupling each of the plurality of PV components 106. In the non-limiting example, cross members 125A, 125B may also be directly coupled to and/or affixed to coupling structures 110, 112. Support structure 124 of PV assembly 102 may include two cross members 125A, 125B, each positioned substantially adjacent a respective, opposing side 118, 120 of the plurality of PV components 106. That is first cross member 125A may be positioned substantially adjacent first side 118, while second cross member 125B may be positioned substantially adjacent second side 120.

Support structure 124 may also include a plurality of legs 126, 128, 130, 132. Each of the plurality of legs 126, 128, 130, 132 may be coupled and/or connected to PV assembly 102. More specifically, each of the plurality of legs 126, 128, 130, 132 may be coupled to a distinct feature, component, and/or portion of support structure 124. In a non-limiting example, each of the plurality of legs 126, 128, 130, 132 may be coupled to a corresponding cross member 125A, 125B; directly or indirectly, for example via hinge 134. For example, and as shown in FIGS. 1-4, first leg 126 and third leg 130 may be coupled to corresponding cross members 125A, 125B via hinge 134. That is, hinge 134 for first leg 126 may be coupled and/or affixed to first cross member 125A, and hinge 134 of third leg 130 may be coupled and/or affixed to second cross member 125B. Additionally in the non-limiting example, second leg 128 may be connected and/or coupled, indirectly (e.g., via an adjustable arm), to first cross member 125A, while fourth leg 132 may be connected and/or coupled, indirectly (e.g., via an adjustable arm), to second cross member 125B. Hinge 134 may allow each leg 126, 130 to move or pivot in a first direction and/or a second direction, or alternatively may be a hinge that allow legs 126, 130 to move freely in any direction that is unobstructed by another portion or component of PV assembly 102.

In the non-limiting example, first leg 126 may be positioned adjacent first side 110 of PV components 106/PV assembly 102 and adjacent a front end 136 of PV components 106/PV assembly 102. Second leg 128 may be positioned adjacent first side 110 of PV components 106/PV assembly 102 and adjacent a back end 138 of PV components 106/PV assembly 102. Similarly, third leg 130 may be positioned adjacent second side 112 and adjacent front end 136 of PV components 106/PV assembly 102, and fourth leg 132 may be positioned adjacent second side 112 and adjacent back end 138 of PV components 106/PV assembly 102. Although four legs are shown, it is understood that PV assembly 102 may include more or less legs for supporting PV components 106 of PV assembly 102.

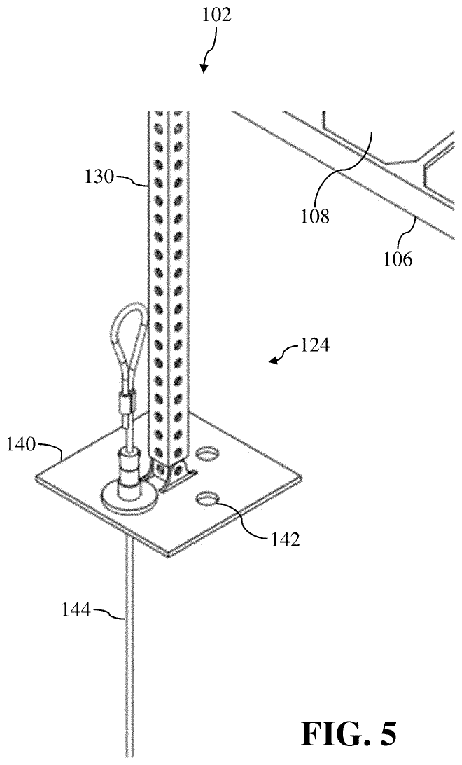

Briefly turning to FIG. 5, and with continued reference to FIGS. 1-4, each of the plurality of legs 126, 128, 130, 132 of support 124 may include a telescoping configuration and/or telescoping legs. As a result of including a telescoping configuration, the height (length) and/or size of each of the plurality of legs 126, 128, 130, 132 may be adjustable and/or variable. Additionally as shown in FIGS. 1-5, each of the plurality of legs 126, 128, 130, 132 may include a base or foot 140 (hereafter, “foot 140”). Foot 140 may be formed on legs 126, 128, 130, 132 opposite hinge 134. In the non-limiting example, foot 140 may be configured as a flat plate that includes an area that is larger than the cross-sectional area of legs 126, 128, 130, 132. Foot 140 formed on each leg 126, 128, 130, 132 may include at least one opening 142 for receiving an anchoring component 144. Anchoring component 144 may be feed through an opening(s) 142 and/or affixed to foot 140 of support structure 124 to anchor and/or hold PV assembly 102 into position. In the non-limiting example, anchoring component 144 may be formed as a tether-type anchor that is inserted and/or secured within the ground and/or sub-surface that supports PV assembly 102 and in which PV assembly 102 is positioned on top of, or over.

Returning to FIGS. 1-4, additionally in the non-limiting examples, support structure 124 of PV assembly 102 may include a plurality of braces 146A, 146B. Braces 146A, 146B may extend between corresponding legs 126, 128, 130, 132 of support structure 124. More specifically, a first brace 146A may extend between and may be coupled to first leg 126 and second leg 128, while second brace 146B may extend between and may be coupled to third leg 130 and fourth leg 132. Braces 146A, 146B may be coupled to and extend between the corresponding legs 126, 128, 130, 132 substantially parallel to a corresponding cross members 125A, 125B. In the non-limiting example, braces 146A, 146B may be releasably coupled to each of the corresponding legs 126, 128, 130, 132 to support, provide structure/rigidity, and/or prevent legs 126, 128, 130, 132 from collapsing when portable PV assembly 102 is in the operational state.

Support structure 124 may also include adjustable arms 148A, 148B. More specifically, adjustable arms 148A, 148B may be positioned adjacent and/or may be coupled to corresponding legs 128, 132. As shown in FIGS. 1-4, first adjustable arm 148A may be positioned adjacent and/or may be coupled directly to second leg 128. Additionally, first adjustable arm 148A may be coupled directly to cross member 125A. Second adjustable arm 148B may be positioned adjacent and/or may be coupled directly to fourth leg 132. Second adjustable arm 148B may also be coupled directly to cross member 125B. Adjustable arms 148A, 148B may be configured to adjust the position, angle, and/or tilt of the plurality of PV components 106. In the non-limiting examples shown in FIGS. 1-4, adjustable arms 148A, 148B may be configured to be coupled to various portions of corresponding legs 128, 132 and/or cross members 125A, 125B, and/or adjustable arms 148A, 148B may be coupled to legs 128, 132 at portions other than an end (e.g., middle, FIG. 4) to adjust the position, angle, and/or tilt of the plurality of PV components 106 of PV assembly 102. Additionally, and similar to legs 126, 128, 130, 132, adjustable arms 148A, 148B may include a telescoping configuration to adjust the length and/or size of each adjustable arms 148A, 148B, and in turn the angle of PV components 106.

In the non-limiting examples, each of the portions of support structure 124 may be releasably coupled to one another using any suitable coupling and/or fastening technique or component(s). For example, braces 146A, 146B may be releasably coupled to the corresponding legs 126, 128, 130, 132 via threaded bolt and nut configuration, or a cotter-pin configuration. As discussed herein, releasably coupling the various components forming support structure 124 may allow for rapid installation and/or set up of PV assembly 102, as well as the ability for support structure 124 of PV assembly 102 to be collapsed and/or stored.

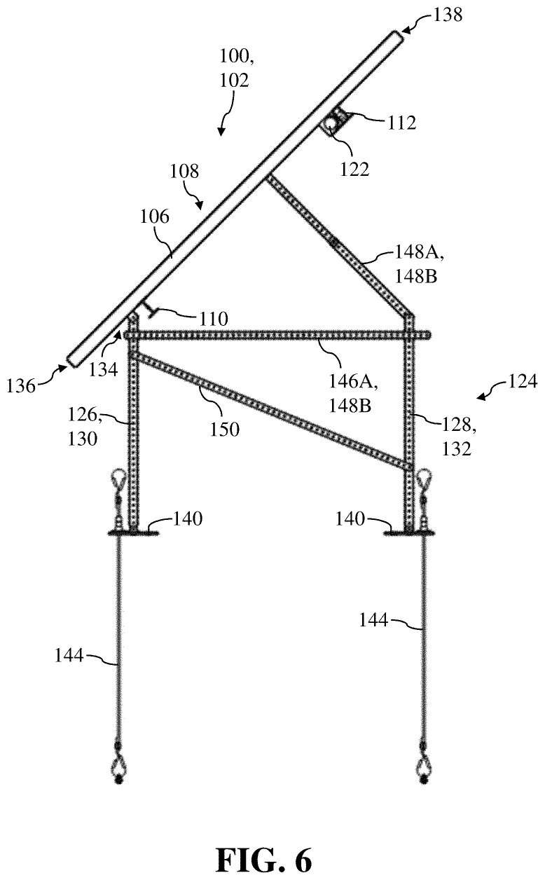

FIG. 6 shows a side view of another non-limiting example of PV assembly 102. It is understood that similarly numbered and/or named components may function in a substantially similar fashion. Redundant explanation of these components has been omitted for clarity.

PV assembly 102 shown in FIG. 6 may also include at least one angled brace 150. More specifically, support structure 124 of PV assembly 102 may include angled brace 150 extending between two distinct legs 126, 128, 130, 132. In a non-limiting example, a first angled brace 150 may extend between and be coupled to first leg 126 and second leg 128, while a second angled brace (behind first angled brace 150) may extend between and be coupled to third leg 130 and fourth leg 132. In another non-limiting example, support structure 124 may include a single angled brace 150 extending between and coupled to first leg 126 and fourth leg 132, or second leg 128 and third leg 130. In an additional non-limiting example (not shown), angled brace 150 may extend between and may be coupled to first leg 126 and third leg 130, or second leg 128 and fourth leg 132. Similar to braces 146A, 146B, angled brace 150 may support, provide structure/rigidity, and/or prevent legs 126, 128, 130, 132 from collapsing when portable PV assembly 102 is in the operational state.

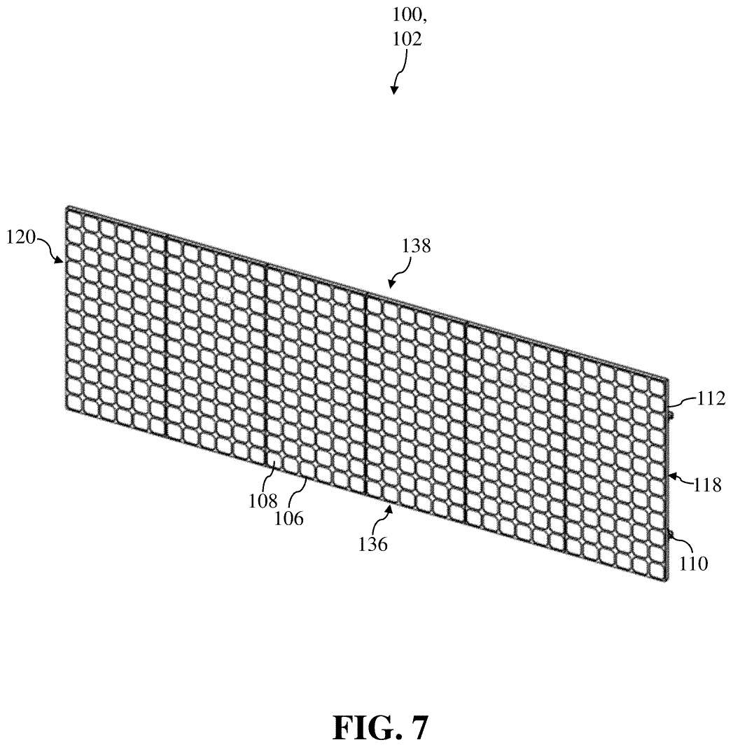

Turning to FIGS. 7-14, various views of portable PV assembly 102 of solar energy system 100 in a collapsed or transportable state may be shown. Portable PV assembly 102 shown in FIGS. 7-14 may be substantially similar to PV assembly 102 of FIGS. 1-4. It is understood that similarly numbered and/or named components may function in a substantially similar fashion. Redundant explanation of these components has been omitted for clarity.

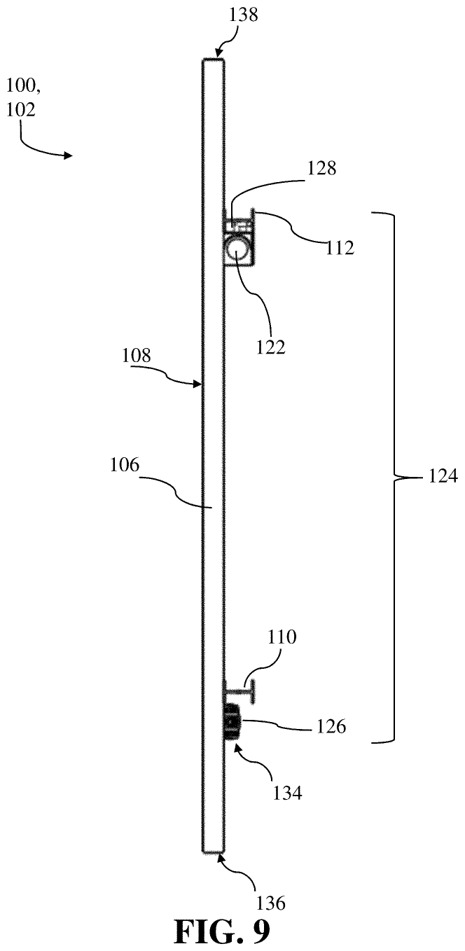

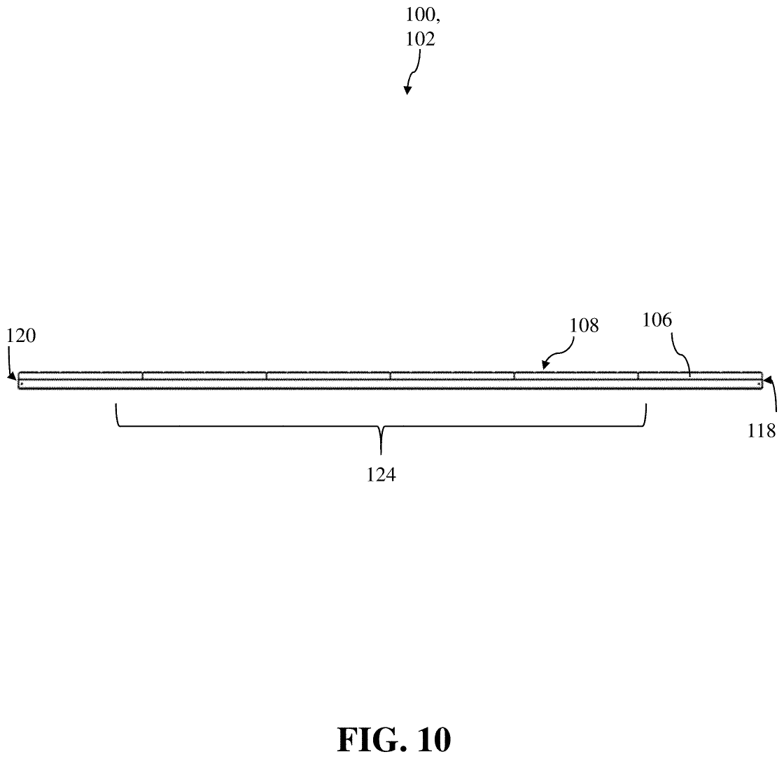

As shown in FIGS. 7-14, when PV assembly 102 of solar energy system 100 is in a collapsed state, all components and/or features, including support structure 124 may be disassembled, folded, and/or configured to be self-contained within the boarders or edges of PV components 106. That is, in the collapsed state of PV assembly 102, all features and/or components forming support structure 124 may be adjusted, moved, rotated, and/or repositioned to be substantially contained within the edges (e.g., sides 118, 120, 136, 138) of PV components 106, and/or may sit substantially against and/or substantially flush with a back surface of PV components 106. As such, and as shown for example in FIG. 10, in the collapsed state, no portion of support structure 124 may extend beyond the edges/ends of PV component 106. Rather, and as shown in the example in FIG. 9, coupling structures 110, 112 may be the only portion of PV assembly 102 that substantially extends from PV component 106.

In the non-limiting example shown in FIGS. 7-14, each of the plurality of legs 126, 128, 130, 132 are shown in the stored and/or collapsed state. In the collapsed state, each of the plurality of legs 126, 128, 130, 132 may be repositioned from the operational state, such that each leg 126, 128, 130, 132 is positioned substantially adjacent and parallel to PV components 106. Additionally in the collapsed state, each of the plurality of legs 126, 128, 130, 132 may be positioned substantially parallel to coupling structures 110, 112. More specifically, first leg 126 and third leg 130 may be positioned substantially adjacent and substantially parallel to first coupling structure 110, while second leg 128 and fourth leg 132 may be positioned substantially adjacent and substantially parallel to second coupling structure 112.

Additionally in the non-limiting example shown in FIGS. 7-14, legs 126, 128, 130, 132 may be turned inward on PV assembly 102 and/or may be turned toward each other in the collapsed state. That is, first leg 126 and third leg 130 may be turned and/or positioned toward one another when positioned substantially parallel with first coupling structure 110 in the collapsed state. Similarly, second leg 128 and fourth leg 132 may turned and/or positioned toward one another when positioned substantially parallel with second coupling structure 112 in the collapsed state.

As shown in FIGS. 7, 8, 13, and 14, each foot 140 positioned on corresponding leg 126, 128, 130, 132 may be hinged, positioned, and/or folded to be substantially parallel with PV components 106 of PV assembly 102. Additionally, and as shown, each foot 140 may be hinged, positioned, and/or folded to be positioned substantially under coupling structures 110, 112. That is, foot 140 may be positioned between coupling structures 110, 112 and PV components 106 when PV assembly 102 is in the collapsed state as shown in FIGS. 7-14.

In the non-limiting example shown in FIGS. 7-14, additional portions of support structure 124 may be positioned substantially adjacent and substantially parallel to PV components 106 and/or coupling structures 110, 112. For example, braces 146A, 146B may be positioned substantially adjacent and substantially parallel to PV components 106 in the collapsed state. Additionally in the collapsed state, braces 146A, 146B may be positioned substantially adjacent and substantially parallel to first coupling structure 110. In the non-limiting example shown in FIGS. 7-14 14, braces 146A, 146B may also be coupled and/or secured to a corresponding leg 126, 130 of support structure 124 in the collapsed state. First brace 146A may be coupled and/or secured to first leg 126 of support structure 124, substantially adjacent first coupling structure 110, while second brace 146B may be coupled and/or secured to third leg 130, substantially adjacent first coupling structure 110.

Additionally, adjustable arms 148A, 148B may also be positioned substantially adjacent and substantially parallel to PV components 106 in the collapsed state. Additionally in the collapsed state, adjustable arms 148A, 148B may be positioned substantially adjacent and substantially parallel to second coupling structure 112. In the non-limiting example shown in FIGS. 7-14, adjustable arms 148A, 148B may also be coupled and/or secured to a corresponding leg 128, 132 of support structure 124 in the collapsed state. First adjustable arm 148A may be coupled and/or secured to second leg 128 of support structure 124, substantially adjacent second coupling structure 112, while second adjustable arm 148B may be coupled and/or secured to fourth leg 132, substantially adjacent second coupling structure 112. As shown in the non-limiting example, each adjustable arm 148A, 148B may be coupled to the corresponding leg 128, 132, and may be positioned substantially between the corresponding leg 128, 132 and PV components 106 in the collapsed state. It is to be understood, that disassembly of coupling structures 110, 112 and features associated with support structure 124 is also possible followed by subsequent stacking to be self-contained within boarders or edges of PV components 106.

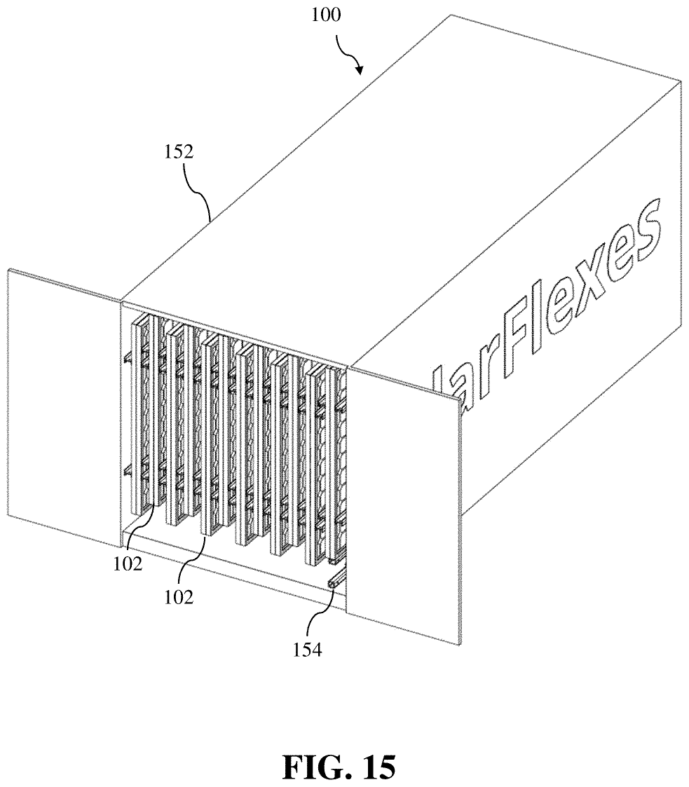

FIGS. 15-17 show various views of solar energy system 100 including a plurality of PV assemblies 102 positioned within a storage container 152 and a trailer 154 for removing and/or aiding in the installation of the PV assemblies 102. In the non-limiting example, the plurality of PV assemblies 102 of solar energy system 100 may be in a collapsed state and may be stored in storage container 152 during storage and/or when transported to the desired installation/operational location.

Storage container 152 may include at least one bracket 156 positioned and/or secured within storage container 152 that may be configured to receive and/or secure at least one PV assembly 102 to prevent damage to PV assemblies 102 during transportation and/or storage. Bracket 156 may include at least one slot 158 that may receive at least one of the plurality of PV assemblies 102. In the non-limiting example shown in FIGS. 15-17 each slot 158 of bracket 156 may house two distinct PV assemblies 102. Additionally in the non-limiting example, the two distinct PV assemblies 102 positioned within a single slot 158 of bracket 156 may be positioned such that each of the PV components 106 and/or solar cells 108 of each PV assembly 102 are positioned directly adjacent one another. As such, and as shown in FIGS. 15-17, coupling structures 110, 112 for each of the two distinct PV assemblies 102 may be positioned opposite one another. Additionally, each of the plurality of slots 158 of bracket 156 may be (vertically) staggered to increase the number of PV assemblies 102 that may be positioned within storage container 152 and/or to prevent coupling structures 110, 112 of adjacent PV assemblies 102 (e.g., PV assemblies positioned in adjacent but distinct slots 158) from undesirably contacting one another during transportation, installation, and/or storage.

Trailer 154 of solar panel system 100 may be utilized to more easily move and/or install PV assemblies 102 of solar panel system 100. As shown in FIGS. 15-17, at least a portion of storage container 152 may include a space (e.g., no bracket 156) in which trailer 154 may be stored and/or kept during transportation of solar panel system 100. Additionally in the non-limiting example, two PV assemblies 102 of solar panel system 100 may be positioned within storage container 152 on trailer 154 during transportation and/or storage.

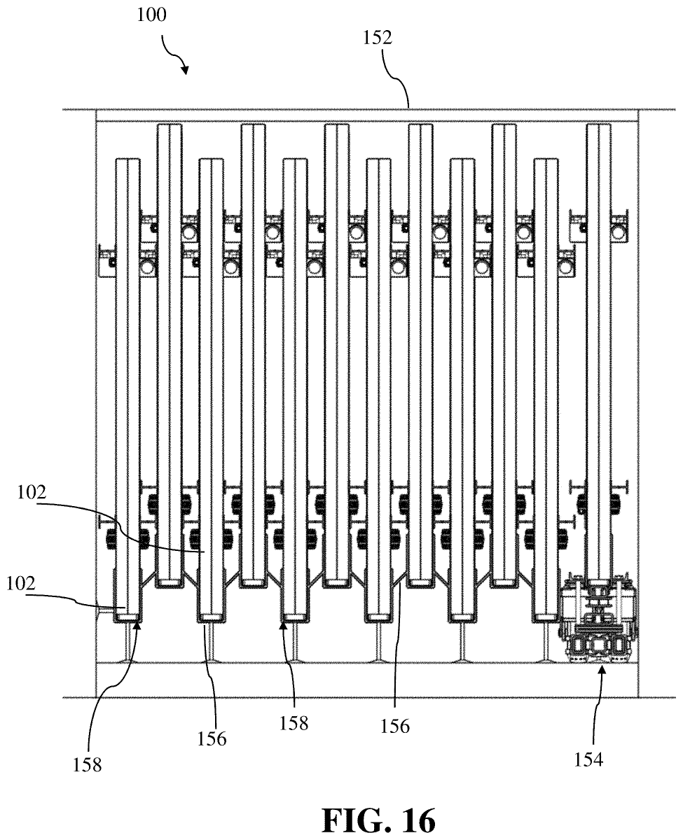

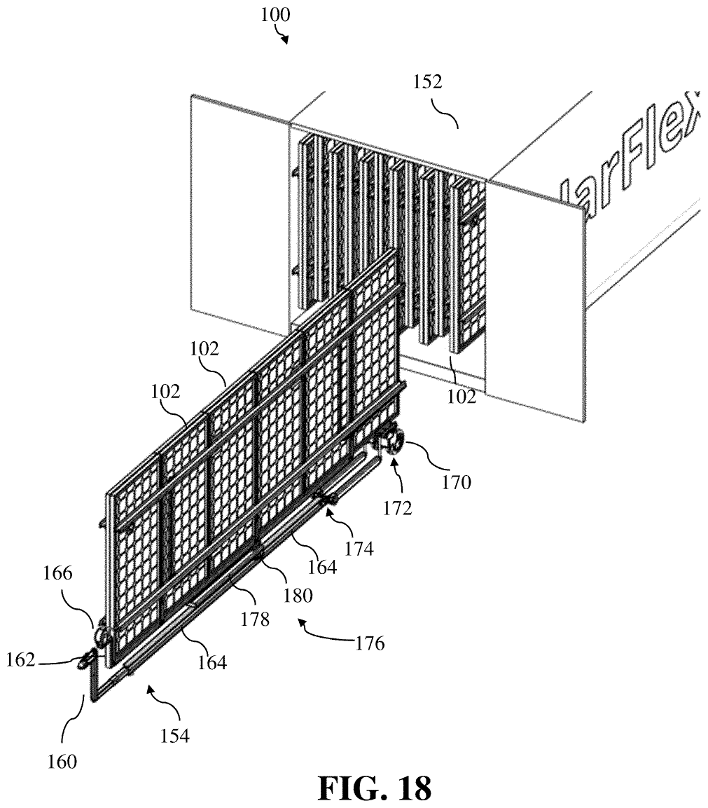

Turning to FIGS. 18-25, and with continued reference to FIGS. 15-17, additional features and operations of solar panel system 100, as well as a process of installing a PV assembly 102 of solar panel system 100 using trailer 154 is now discussed. As shown in FIGS. 15 and 16, trailer 154 may be at least partially modular to fit into storage container 152. That is, a trailer hitch portion 160 and a winch portion 162 may be releasably coupled to the remainder of the frame 164 of trailer 154 to allow trailer 154, and more specifically frame 164 of trailer 154, to fit into storage container 152. During transportation and/or storage, hitch portion 160 and winch portion 162 may be removed from and/or not coupled to frame 164 of trailer 154 to allow storage container 152 to close and/or be secured.

Hitch portion 160 coupled to frame 164 of trailer 154 may provide a trailer hitch or any suitable connection component to allow for transporting and/or moving trailer 154. That is, trailer hitch of hitch portion 160 provides installers the ability to tow or move trailer 154 during the installation process. Additionally, winch portion 162 includes a winch 166. Winch 166 may be configured to be connected to and move PV assemblies 102 from storage container 154 onto frame 164 of trailer 154 during the installation process.

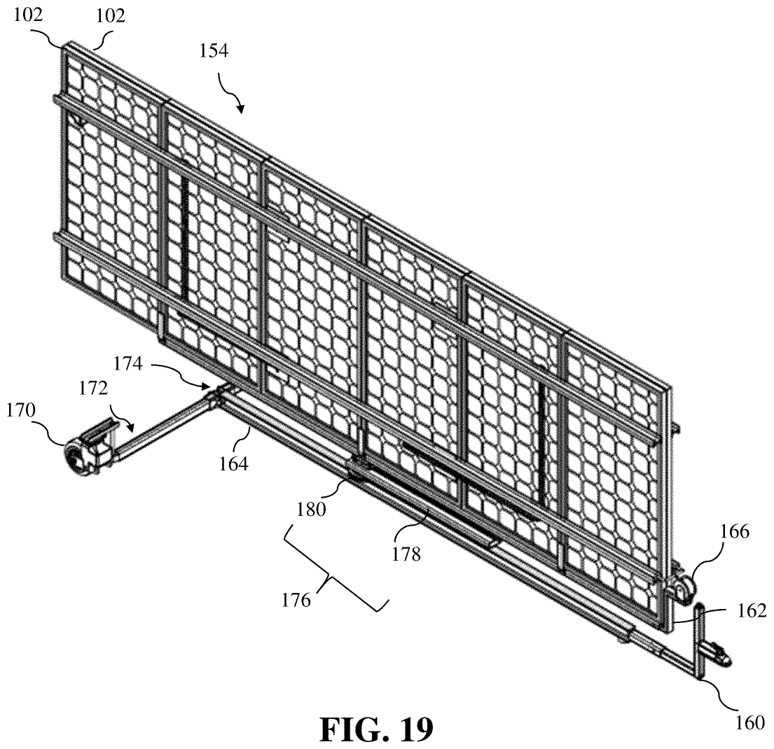

As shown in FIG. 18, two PV assemblies 102 may be positioned on frame 164 of trailer 154, and may be removed from storage container 152. In a non-limiting example, the two PV assemblies 102 positioned on frame 164 may be the two PV assemblies 102 included on trailer 154 during the transportation of storage container 152 of solar panel system 100. Once the two PV assemblies 102 and the trailer 154 are removed from container 152, the configuration of frame 164 may be adjusted for transporting trailer 154 and/or for providing stability to trailer 154 during the installation process. For example, and as shown in FIG. 19, the position of wheels 170 of trailer 154 may be adjusted and/or extended via a first hinge 172 and a second hinge 174 formed on frame 164. Extending and/or adjust the position of wheels 170 (compare FIGS. 18 and 19) may provide added stability to trailer 154 as it is moved and/or during installation of PV assemblies 102. In another non-limiting example, once the initial two PV assemblies 102 are removed from frame 164, another two PV assemblies 102 may be positioned on frame 164 from within a single slot 158 of bracket 156 within storage container 152. In this non-limiting example, the two PV assemblies 102 may be positioned, slid, and/or moved onto frame 164 of trailer 154 using winch 166 included on winch portion 162. That is, winch 166 may be connected to two PV assemblies 102 positioned in single slot 158 of bracket 156 positioned within storage container 152, and may be used to pull the two PV assemblies 102 onto frame 164 of trailer 154.

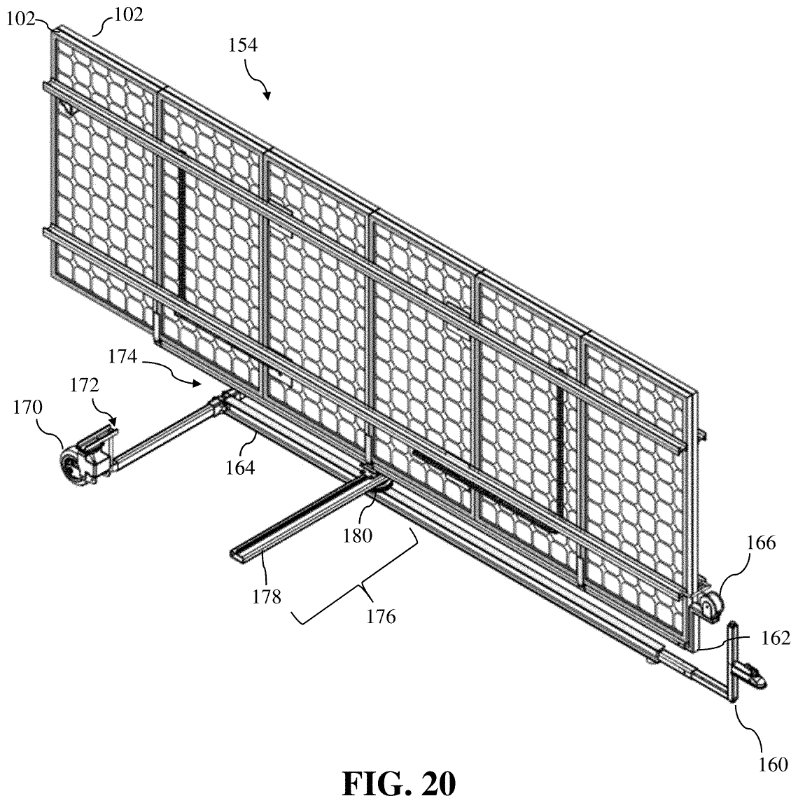

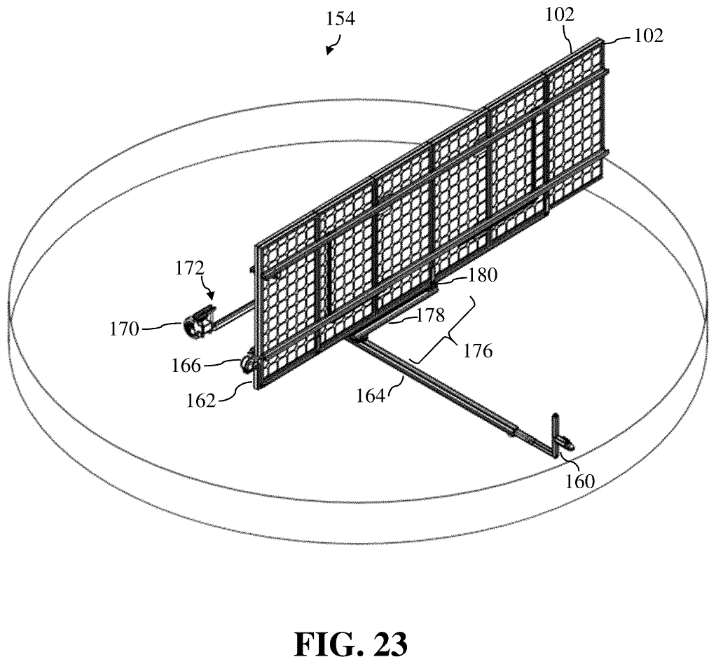

Trailer 154 may also include a positional slider system 176 that may allow for PV assemblies 102 to be positioned at various angles and/or orientations on trailer 154 during the installation process (see, FIG. 23). As shown in FIGS. 20-23, positional slider system 176 may be positioned on frame 164 of trailer 154 and may receive and/or hold PV assemblies 102 during the installation process. Positional slider system 176 may include a slide track 178 that may extend from frame 164 of trailer 154 and rotate 360 degrees on frame 164 of trailer 154. Additionally, positional slider system 176 may include a roller 180 coupled to slide track 178 and PV assemblies 102, respectively. Roller 180 may be configured to move along and/or slide within slide track 178 of positional slider system 176. Additionally roller 180 may be configured to rotate 360 degrees within slide track 178. As a result of roller 180 receiving and/or supporting the two distinct PV assemblies 102, roller 180 allows and/or is configured to move PV assemblies 102 along slide track 178 and/or may allow PV assemblies 102 to rotate on slide track 178 during the installation process. For example, and as shown in FIGS. 19-22, PV assemblies 102 may freely move along slide track 178 and/or rotate on slide track 178 via roller 180. The full range of motion of PV assemblies 102 moving on slide track 178 of positional slider system 176 is shown in FIG. 23 and indicated by cylindrical periphery 177.

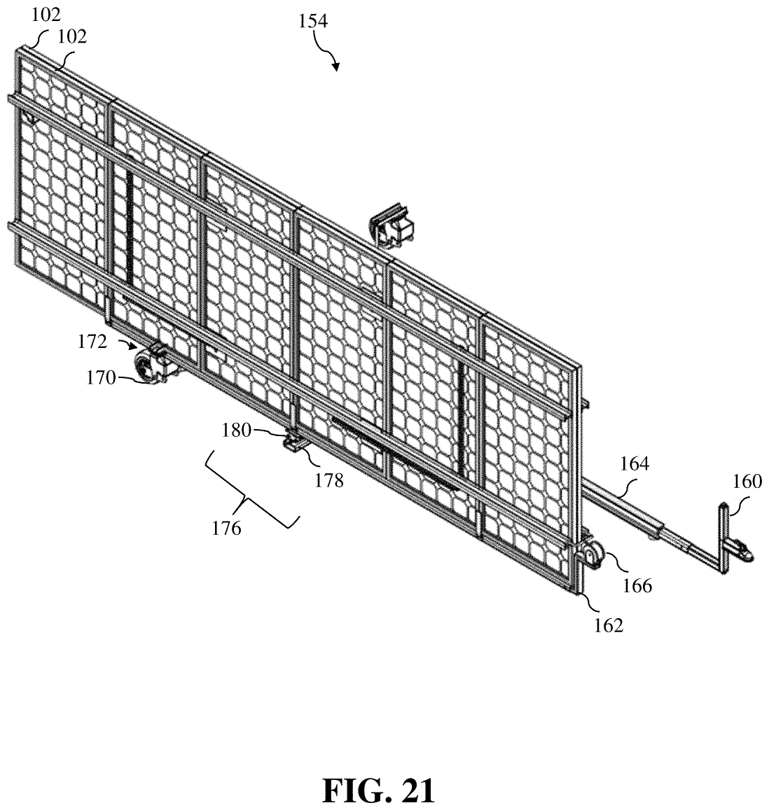

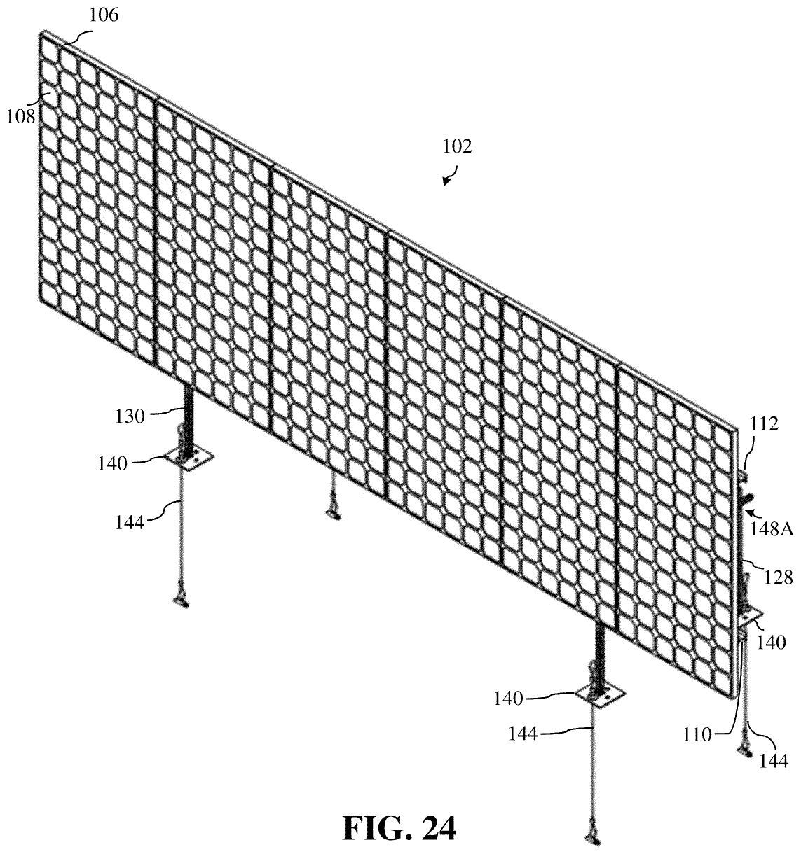

Once the two distinct PV assemblies 102 are positioned and/or oriented/angled in the desired location of installation, one of the two distinct PV assemblies 102 may be removed from trailer 154 and set up in the operational state (e.g., FIGS. 1-4). For example, and as shown in FIGS. 21 and 24, PV assemblies 102 included on trailer 154 may be positioned in the desired location. In one example, PV assembly 102 positioned closest to frame 164 of trailer 154 may be installed and/or set in the operational state first. As shown in FIG. 24, support structure 124 may be set-up to support PV assembly 102 first. Specifically, legs 126, 128, 130, 132 may be installed and/or positioned on the surface supporting PV assembly 102. Additionally, braces 146A, 146B may be coupled to the respective legs 126, 128, 130, 132. Once the portions of support structure 124 are installed, as shown in FIG. 24, trailer 154 including the remaining PV assembly 102 may be moved away from the partially installed PV assembly 102 to allow an installer/operator to finish putting PV assembly 102 in the operational state.

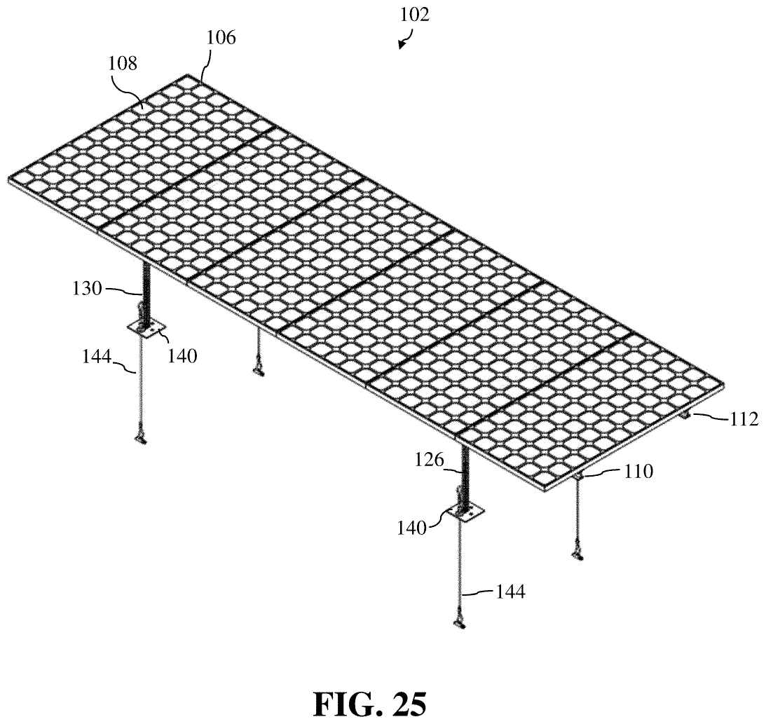

Turning to FIG. 25, and with continued reference to FIG. 24, PV components 106 including solar cells 108 may be folded down toward legs 128, 132, respectively, to complete the installation process. In the non-limiting example, PV components 106 may be folded down toward legs 128, 132, via hinges 134, so adjustable arms 148A, 148B may be installed and/or coupled to legs 128, 132 and cross members 125A, 125B, respectively. Once adjustable arms 148A, 148B are coupled to corresponding legs 128, 132 and cross members 125A, 125B, the angle, position, and/or tilt of PV components 106 of PV assembly 102 may be adjusted to the desired position, and PV assembly 102 may be in the installed or operational state.

To install the second of the two PV assemblies 102 positioned on trailer 154, the same steps may be repeated as discussed herein with respect to FIGS. 21-25. In another non-limiting example, the second PV assembly 102 remaining on trailer 154 may first need to be rotated 180 degrees using positional slider system 176 (e.g., slide track 178, roller 180) so it may be oriented next to, but in a similar position and/or configuration as the PV assembly 102 previously installed. Once both PV assemblies 102 are installed using trailer 154, trailer 154 may return to storage container 152 and may remove and/or receive two more distinct PV assemblies 102 for installation.

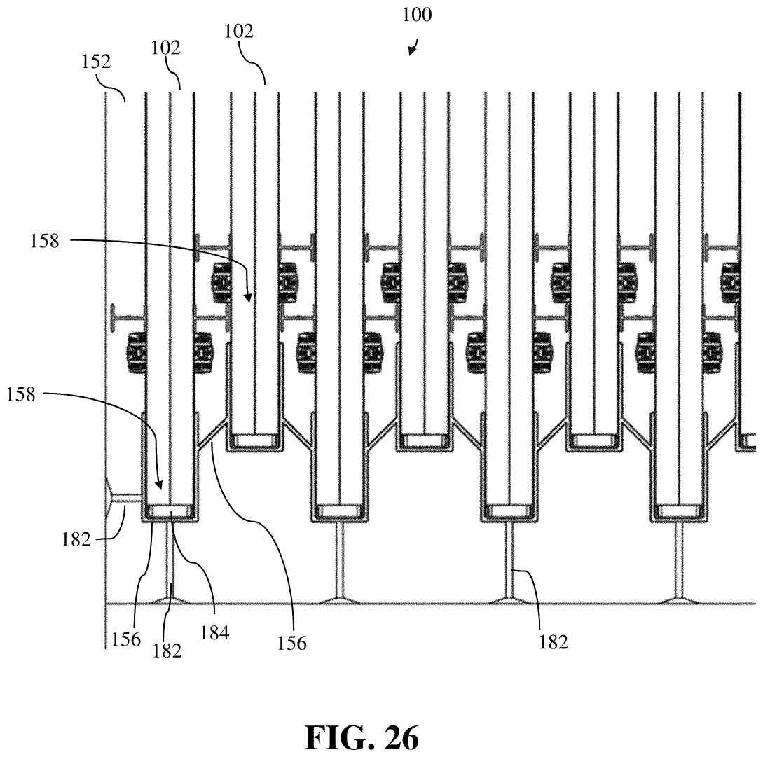

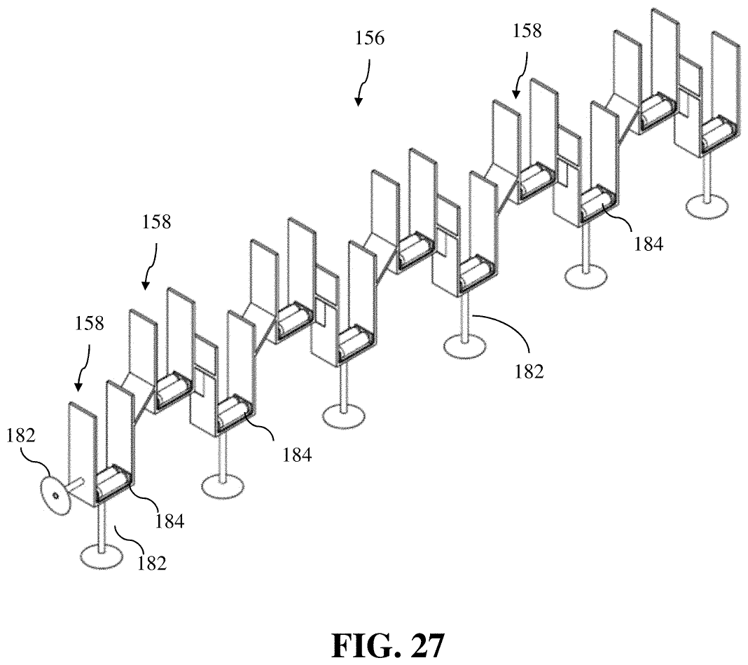

FIGS. 26 and 27 show additional detailed views of bracket 156 included within storage container 152. As shown in the non-limiting example, and as discussed herein, bracket 156 may include a plurality of (vertically) staggered slots 158 for receiving PV assemblies 102. Additionally, bracket 156 may include a plurality of adjustable feet 182. Adjustable feet 182 may secure and/or hold bracket 156 within storage container 152, as well as provide the ability for the height of bracket 156 to be adjusted to prevent PV assemblies 102 from undesirably shifting and/or contacting storage container 152 during storage/transportation/installation. Additionally as shown in FIGS. 26 and 27, brackets 156 may include a roller bed or bearings 184 (hereafter “bearings 184”) positioned within each slot 156. When received and/or positioned in bracket 156, PV assemblies 102 may be positioned on and/or may contact bearings 184 included in slots 158. Bearings 184 may aid in allowing PV assemblies 102 to more easily slide and/or roll in and out of bracket 156 during the installation and/or storage process, a discussed herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A solar energy system comprising:
a plurality of photovoltaic (PV) assemblies, each of the plurality of PV assemblies including:
a plurality of PV components;
at least one coupling structure coupled to each of the plurality of PV components; and
a support structure coupled to the at least one coupling structure, the support structure including:
at least two cross members coupled to and extending substantially perpendicular to the at least one coupling structure;
at least four legs coupled to one of the at least two cross members; and
at least two adjustable arms extending between and coupled to one of the at least two cross members and one of the at least four legs.

2. The solar energy system of claim 1, further including a brace extending between and coupled to two of the at least four legs.

3. The solar energy system of claim 1, wherein at least one of the at least four legs is adjustable.

4. The solar energy system of claim 1, wherein at least one of the at least four legs is hingedly coupled to the at least two cross members.

5. The solar energy system of claim 1, wherein at least one of the at least four legs includes a foot, the foot including a flat plate with an area larger than a cross-section of any of the at least four legs.

6. The solar energy system of claim 5, wherein the foot includes an anchoring component for securing the plurality of PV assemblies.

7. The solar energy system of claim 1, wherein the at least two adjustable arms adjust at least one of angle, positions, and tilt of the plurality of PV components of the plurality of PV assemblies.

8. The solar energy system of claim 1, further including a storage container for receiving the plurality of PV assemblies.

9. The solar energy system of claim 8, wherein the storage container includes a bracket positioned on a surface of the storage container for receiving one or more of the plurality of PV assemblies.

10. The solar energy system of claim 9, wherein the bracket includes a plurality of slots for receiving one or more of the plurality of PV assemblies.

11. The solar energy system of claim 10, wherein the plurality of slots for receiving one or more of the plurality of PV assemblies are disposed at vertically staggered positions in the storage container.

12. The solar energy system of claim 10, wherein each of the plurality of slots includes bearings therein.

13. The solar energy system of claim 1, further including an installation trailer to receive and transport at least one PV assembly of the plurality of PV assemblies.

14. The solar energy system of claim 13, wherein the installation trailer includes a positional slider system positioning at least one of the plurality of PV assemblies at various angles and orientations for installation.

15. The solar energy system of claim 14, wherein the installation trailer includes a frame, and the positional slider system includes a slide track on the frame, the slide track extending in 360 degrees from the frame of the installation trailer.

16. The solar energy system of claim 15, wherein the slide track includes a roller, the roller enabling movement of the slide track and rotation on the slide track on the frame.

17. The solar energy system of claim 13, further including a storage container for receiving the plurality of PV assemblies, wherein the installation trailer can be stored in the storage container.

18. The solar energy system of claim 17, wherein the installation trailer can insert at least one PV assembly of the plurality of PV assemblies into the storage container, and transport at least one PV assembly of the plurality of PV assemblies from the storage container.

19. The solar energy system of claim 13, the installation trailer further including a winch to connect to and move at least one PV assembly of the plurality of PV assemblies onto the installation trailer during installation.

20. A solar energy system comprising:
a plurality of photovoltaic (PV) assemblies, each of the plurality of PV assemblies including:
a plurality of PV components;
at least one coupling structure coupled to each of the plurality of PV components; and
a support structure coupled to the at least one coupling structure, the support structure including:
at least two cross members coupled to and extending substantially perpendicular to the at least one coupling structure;
at least four legs coupled to one of the at least two cross members; and
at least two adjustable arms extending between and coupled to one of the at least two cross members and one of the at least four legs;
wherein at least one of the at least four legs is adjustable; and
wherein at least one of the at least four legs is hingedly coupled to the at least two cross members; and
wherein the at least two adjustable arms adjust at least one of angle, position, and tilt of the plurality of PV components of the plurality of PV assemblies.
